(19) United States
(12) Patent Application Publication
(10) Pub. No.: US 2026/0042550 A1
(43) Pub. Date: Feb. 12, 2026

(54) COOLING DEVICE FOR AIRCRAFT

(71) Applicant: UNITED AIRLINES, INC., Chicago, IL (US)

(72) Inventor: William J. Rushin, Greenwood, IN (US)

(21) Appl. No.: 18/797,154

(22) Filed: Aug. 7, 2024

(51) Int. Cl. B64F 1/36

(52) U.S. Cl. CPC B64F 1/362

(57) ABSTRACT

Systems and methods for cooling an aircraft bay are provided that include a base plate defining a body and including an opening formed, thereon, a hose coupling bracket operably coupled with the base plate and being positioned at or near the opening, and at least one support arm movably coupled with the base. The body of the base plate and the at least one support arm define a gap to receive a portion of a fuselage of an aircraft therebetween.

### FIELD

The present disclosure is related to a cooling device for an aircraft.

### BACKGROUND

Most commercial aircraft include a number of complex electrical systems and components used to assist with the operation thereof. Such electrical systems are typically retained in an electrical and electronics (“E&E”) bay, which may be in the form of an internal volume of the aircraft accessible by a service door. During the summer months and in generally warm environments, the electrical components within the E&E bay may overheat during the loading/unloading process while the aircraft is on the ground. Given the size constraints of the E&E bay, it may be difficult to lower the component and bay temperatures in an efficient and timely manner. Such overheating instances may require a number of airline personnel to attempt to lower the temperature of this bay, which may lead to increased personnel costs. Additionally, overheating instances may result in flight delays and/or cancellations, thus increasing operational expenses for an airline.

Further, as aircraft continue to advance from a technological perspective, additional, higher-powered electrical equipment may be required for operation. This increase in electrical equipment may also contribute to increases in temperatures within the E&E bay.

Accordingly, there is a need for improved devices having improved functionalities.

### SUMMARY

Systems and methods for cooling an aircraft bay are provided that include a base plate defining a body and including an opening formed, thereon, a hose coupling bracket operably coupled with the base plate and being positioned at or near the opening, and at least one support arm movably coupled with the base. The body of the base plate and the at least one support arm define a gap to receive a portion of a fuselage of an aircraft therebetween.

In some variations, the system may further include a supply hose that couples with the hose coupling bracket to supply preconditioned air to the aircraft bay. In some examples, the system may further include a screen member positioned within an interior region of the hose coupling bracket. In these and other approaches, the system may further include at least one gripping pad that is operably coupled with the base plate or the at least one support arm.

In some arrangements, the securing knob is rotatably coupled with a portion of the at least one support arm. The securing knob and the at least one support arm cooperate to reduce a dimension of the gap formed between the body of the base plate and the at least one support arm. In such examples, the base plate may additionally include at least one linear guide slot adapted to guide movement of the at least one support arm along a linear direction. In such arrangements, the system may additionally include a stop coupled with the base plate that limits movement of the at least one support arm.

In some examples, the hose coupling bracket may include a rotational engagement mechanism.

In accordance with a second aspect, an approach for cooling an aircraft bay may include removing an access door to expose a fuselage opening formed in a fuselage of the aircraft. The method may further include providing a base plate defining a body and including an opening formed thereon and a hose coupling bracket operably coupled therewith and being positioned at or near the opening. The base plate may have at least one support arm movably coupled therewith. The at least one support arm is positioned in a first, inward position with respect to the base plate and a portion of the body of the base plate is inserted in the fuselage opening such that the body abuts a portion of the fuselage. The at least one support arm is positioned in a second, outward position with respect to the base plate such that the fuselage is disposed within a gap between the body and the at least one support arm. A supply hose is then coupled with the hose coupling bracket.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed invention, and explain various principles and advantages of those examples.

FIG. 1 illustrates a perspective view of an aircraft having an example cooling system coupled thereto in accordance with various examples.

FIG. 2 illustrates a perspective view of the example cooling system of FIG. 1 in accordance with various examples.

FIG. 3 illustrates a lower perspective view of the example cooling system of FIGS. 1 & 2 coupled with the example aircraft in accordance with various examples.

FIG. 4 illustrates an upper perspective view of the example cooling system of FIGS. 1-3 in accordance with various examples.

FIG. 5 illustrates a lower perspective view of the example cooling system of FIGS. 1-4 in accordance with various examples.

FIG. 6 illustrates a front elevation view of the example cooling system of FIGS. 1-5 in accordance with various examples.

FIG. 7 illustrates a lower perspective view of a portion of the example cooling system of FIGS. 1-6 in accordance with various examples.

FIG. 8 illustrates a lower perspective view of a portion of the example cooling system of FIGS. 1-7 in accordance with various examples.

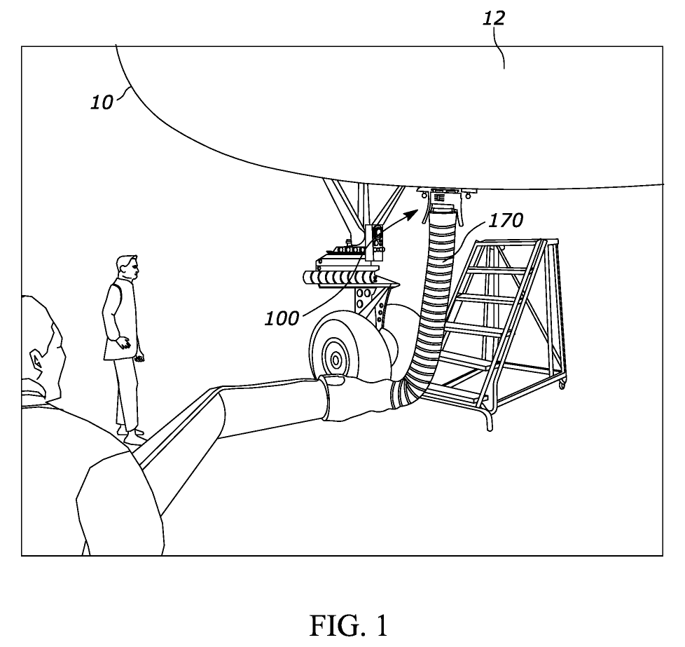

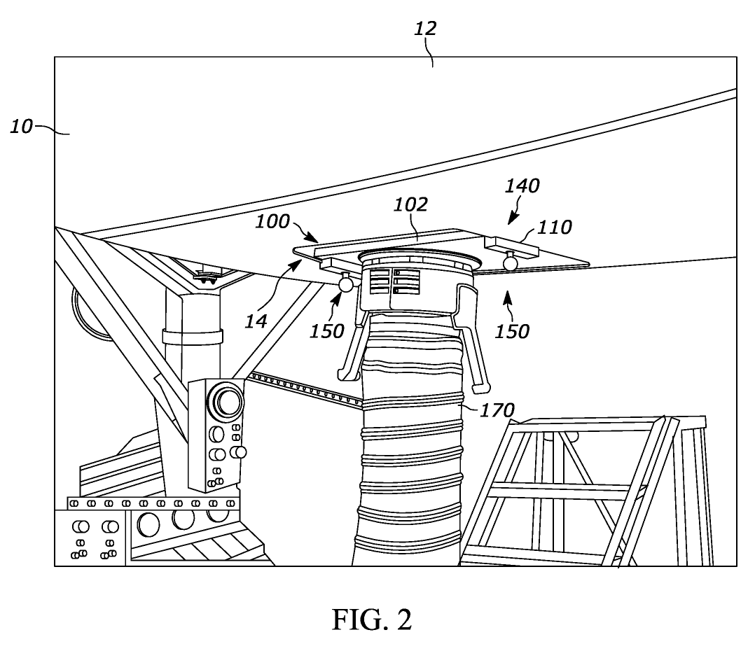

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in commercially feasible examples which are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

The apparatus and method components have been represented where appropriate by conventional symbols in the drawings, showing only those specific details that are pertinent to understanding examples of the present disclosure so as not to obscure the disclosure with details that will be readily apparent to those of ordinary skill in the art having the benefit of the description herein.

Although the figures may show parts with clean lines and boundaries, some or all of these lines and/or boundaries may be idealized. In reality, the boundaries and/or lines may be unobservable, blended, and/or irregular. Use of terms such as up, down, top, bottom, side, end, front, back, etc. herein are used with reference to a currently considered or illustrated orientation. If they are considered with respect to another orientation, it should be understood that such terms must be correspondingly modified.

### DETAILED DESCRIPTION

Generally speaking, the systems and approaches described herein allow for the efficient cooling of aircraft E&E bays in addition to any other internal aircraft volume that may benefit from preconditioned air. The system may be quickly mounted to the aircraft by a technician who needn’t remain present during the cooling process, therefore affording them the ability to attend to other tasks while the aircraft is on the ground.

Turning now to the figures, an aircraft 10 is illustrated. The aircraft 10 may be in the form of any commercial or private aircraft adapted to carry passengers and/or cargo, and may include a body or fuselage 12 as well as any number of additional features (e.g., engines, aerodynamic surfaces, a cockpit, structural components, wing and/or body fairings to couple the aerodynamic surfaces to the aircraft body, and the like). For the sake of brevity, such features, components, systems, and/or subsystems will not be discussed in further detail herein. In various examples, the aircraft 10 may include various sensors, electrical, mechanical, and/or electromechanical systems (not shown) common and typical in commercial airliners. These components may be primarily retained in an aircraft bay 16 (e.g., an E&E bay) that is accessible via an opening 14. While not illustrated, such an opening 14 may be covered via a door, hatch, or similar component when access to the components disposed therein is not required (e.g., during aircraft flights).

As previously noted, the aircraft bay 16 may be dimensioned to accommodate the electrical equipment used to operate the aircraft 10. As a non-limiting example, the aircraft bay 16 may retain components such as, for example, flight control computers, communications systems, navigation systems and controllers, power supplies, and the like. Other examples are possible.

The cooling system 100 may be coupled with the fuselage 12 to supply preconditioned air to the aircraft bay 16. The cooling system 100 includes a base plate 102, a hose coupling bracket 120, a support arm 140, and a supply hose 170. The base plate 102 includes a body 104 that defines a base plate opening 106 and at least one linear guide slot 108. In the illustrated examples, only the center-most linear guide slot 108 extends entirely through the body 104, whereas the outermost linear guide slots 108 only extend a partial length through the body 104. However, in other implementations, each or any number of the linear guide slots 108 may extend entirely through the length of the body 104 as desired. The base plate 102 may be constructed from any number of suitable materials such as, for example, polymers, metals, synthetic materials, and/or combinations thereof. The base plate 102 may further include any number of gripping pads 110 coupled therewith and/or formed thereon. The gripping pad(s) 110 may be constructed from a material such as rubber that frictionally engages the fuselage 12 when the cooling system 100 is in use.

The base plate opening 106 is dimensioned to allow preconditioned air to enter into the aircraft bay 16. The hose coupling bracket 120 is adapted to at least partially cover the base plate opening 106. More specifically, the hose coupling bracket 120 may be in the form of a first plate 122 and a second plate 124. These first and second plates may be disposed on opposite sides of the body 104 of the base plate 102. For example, the first plate 122 may be disposed on a first side 104a of the body 104, and the second plate 124 may be disposed on a second side 104b of the body 104. The first and second plates 122, 124 may be constructed from any number of suitable materials such as, for example, metals, polymers, and/or any combination thereof. In the illustrated example, the first and the second plates 122, 124 are each in the form of ring members. However, any suitable shape or configuration may be envisioned.

In the illustrated examples, the first plate 122 receives a screen member 126 in an interior region 122a thereof. More specifically, this screen member 126 may serve as a filter to block, limit, or otherwise prevent certain particles from entering into the aircraft bay 16. The screen member 126 may be coupled with the first plate 122 via any number of suitable approaches such as, for example, a press-fit connection, a threaded connection, welding, ultrasonic welding, adhesives, and the like. Other examples are possible. It is to be appreciated that in other arrangements, the screen member 126 may be carried by or otherwise coupled with the second plate 124 as desired.

Also in the illustrated examples, the second plate 124 includes a hose engagement member 128. In these examples, the hose engagement member 128 is in the form of a curved slot that is dimensioned to receive a corresponding engagement protrusion (not illustrated) carried by the supply hose 170.

The first and second plates 122, 124 may be coupled with the base plate 102 by first positioning each of the respective plates 122, 124 on the body 104 of the base plate 102 and aligning through-holes 127 formed on each of the plates 122, 124 with corresponding through-holes 107 formed on the body 104. In some arrangements, each of the plates 122, 124 may include a ledge or lip (not illustrated) that is dimensioned to next within the base plate opening 106. The user may then secure the first and second plates 122, 124 via fasteners 125, which, in the illustrated examples, are in the forms of bolts or screws that engage with a nut. Other suitable arrangements for securing or otherwise coupling the first and second plates 122, 124 may be provided.

It is to be appreciated that in some examples, the hose coupling bracket 120 may only include one plate that retains the screen member and the hose engagement member.

The support arm 140 includes a body 142 having an upper region 142a and a lower region 142b. The upper region 142a includes any number (e.g., two) of engagement fingers 144 extending therefrom. A first ledge 146 is also positioned at or near the upper region 142a. A second ledge 148 is positioned at or near the lower region 142b and is dimensioned to receive any number of (e.g., two) gripping pads 110.

The body 142 of the support arm 140 further includes a through-hole 147. This through-hole 147 is dimensioned to receive a securing knob 150 therethrough. More specifically, the securing knob 150 includes a gripping member 152, a rod 154, and a rotational lock 156. The rod 154 may be threaded such that rotation of the gripping member 152 causes the gripping member 152 to traverse a length of the rod 154. Put differently, the gripping member may raise or lower with respect to the rod 154. Because the gripping member 152 is positioned at or near the lower region 142b of the body 142 such that the gripping member 152 contacts the body 142, rotating the gripping member 152 also causes the body 142 to be raised or lowered relative to the rod 154.

In the illustrated examples, the cooling system 100 incorporates two support arms 140. Each of these support arms 140 is movably coupled with the base plate 102 using the securing knob 150. More specifically, in some arrangements, the gripping member 152 may be unthreaded from the rod 154 such that the rod 154 may be inserted into the linear guide slot 108 of the body 104 and through the through-hole formed on the body 142 of the support arm 140, whereupon the rod 154 may protrude outwardly from the lower region 142b of the body 142. Each of the engagement fingers 144 formed on the body 142 may also be inserted into or otherwise aligned with the linear guide slots 108 of the base plate 102. The gripping member 152 may then be threaded onto the rod 154, thereby preventing the support arm 140 from decoupling from the base plate 102.

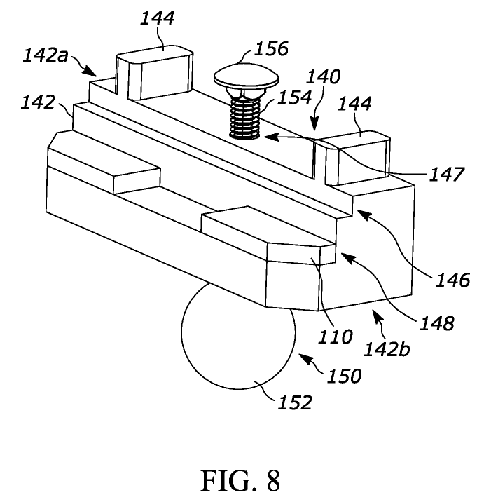

As illustrated in FIG. 8, in some examples, a rotational lock 156 may be provided at the end of the rod 154. This rotational lock 156 may be inserted into the linear guide slot 108 to prevent the rod 154 from rotating relative to the linear guide slot 108 and thus the base plate 102. More specifically, the rotational lock 156 may be in the form of wings that engage or otherwise abut against a sidewall or sidewalls of the linear guide slot 108 when twisting or rotating the gripping member 152.

As previously noted, each of the support arms 140 is slidably coupled with the base plate 102. More specifically, each of the support arms 140 is separately movable between an inward position (i.e., a position or direction near the base plate opening 106 and the hose coupling bracket 120) and an opposite outward position. Notably, relative rotational movement between the support arm(s) 140 and the base plate 102 is restricted due to the engagement fingers 144 being disposed within respective linear guide slots 108. Additionally, because each engagement finger 144 is relatively elongated with respect to the length of the linear guide slot 108, relative rotation may further be limited. Further, outward movement of each support arm 140 may be stopped or otherwise limited by the rod 154 and/or engagement fingers 144 abutting the end of their respective linear guide slot 108 or when the first ledge 146 of the support arm abutting the gripping pad 110 carried by the base plate 102. In the latter example, the gripping pad 110 carried by the base plate 102 may serve as a stop or abutment member.

So arranged, the body 104 and the support arm 140 cooperate to define a gap 160 therebetween that may be selectively lengthened or shortened by engaging the gripping member 152 of the securing knob 150. While the size of the gap 160 is decreased in the illustrated examples due to the presence of two gripping pads 110, the overall dimension of the gap 160 may still be adjusted as desired. In operation, to couple the cooling system 100 with the aircraft 10, a user first loosens the securing knob or knobs 150 so that each support arm 140 may be positioned in the inward position. If desired, the user may tighten the securing knob 150 at this point to “lock” the support arms 140 in this inward orientation.

Upon removing the access door (not illustrated) of the fuselage 12 from the aircraft 10 to expose the opening 14, a user may then insert the body 104 of the base plate 102 into the opening 14 such that the body 104 (and any gripping pad(s) 110 coupled therewith or otherwise formed thereon) rests on an interior surface of the fuselage 12 inside of the aircraft bay 16. A user may then loosen the securing knobs 150 and slide each support arm 140 outwardly until the second ledge 148 (and any gripping pad(s) 110 coupled therewith or otherwise formed thereon) are generally positioned below the fuselage 12. Next, a user may tighten the securing knob 150 by twisting the gripping member 152, thereby raising the body 142 of the support arm until it contacts or comes in close contact with an exterior surface of a portion of the fuselage 12. Next, the user may couple the supply hose 170 with the hose coupling bracket 120 by rotating the supply hose 170 to engage the hose engagement member 128. In some examples, a relative rotation between approximately 5° and approximately 25° (e.g., approximately 13°) is used to couple the supply hose 170 with the hose coupling bracket 120, but it is to be appreciated that other values and/or coupling approaches may be used. Advantageously, the hose coupling bracket 120 may have a similar or identical configuration as the bracket used to couple with the aircraft to provide preconditioned air to the interior cabin during loading and/or unloading. As a result, a single supply hose 170 having a common connection bracket or plate may be used to provide preconditioned air to both locations of the aircraft as needed.

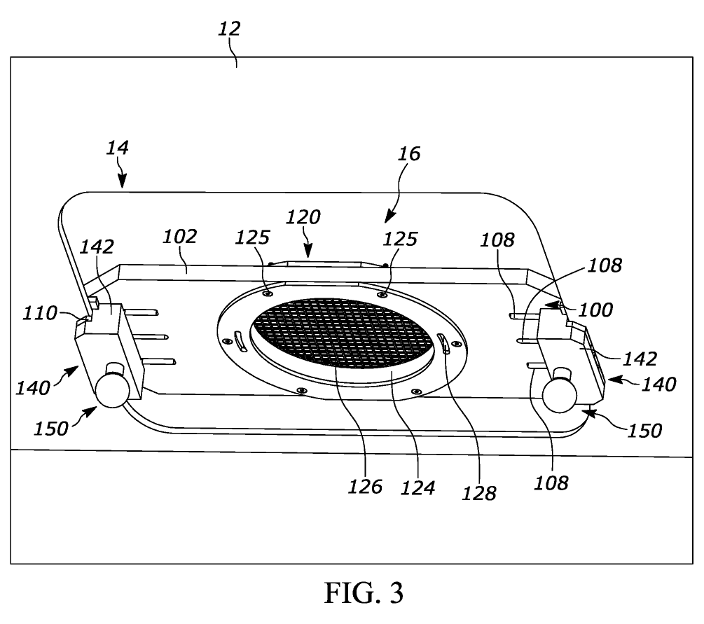

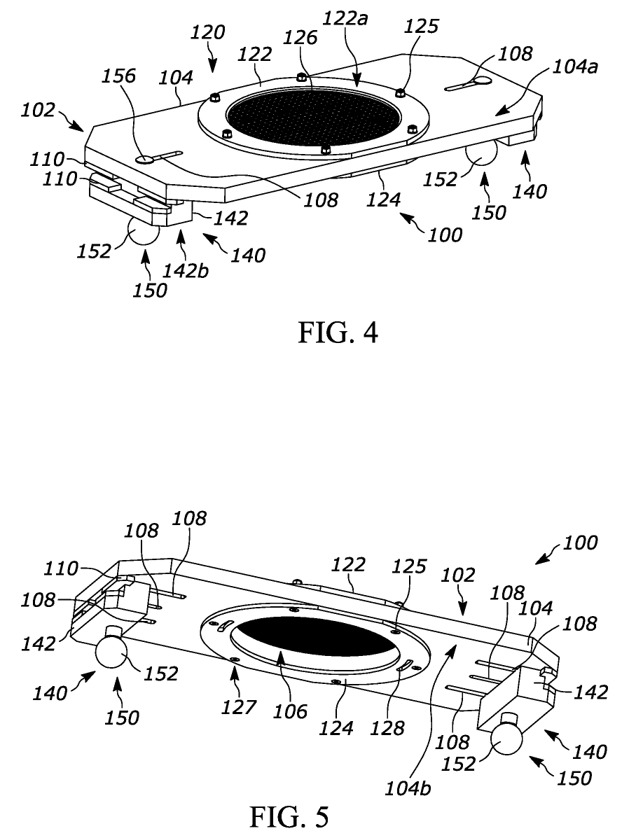

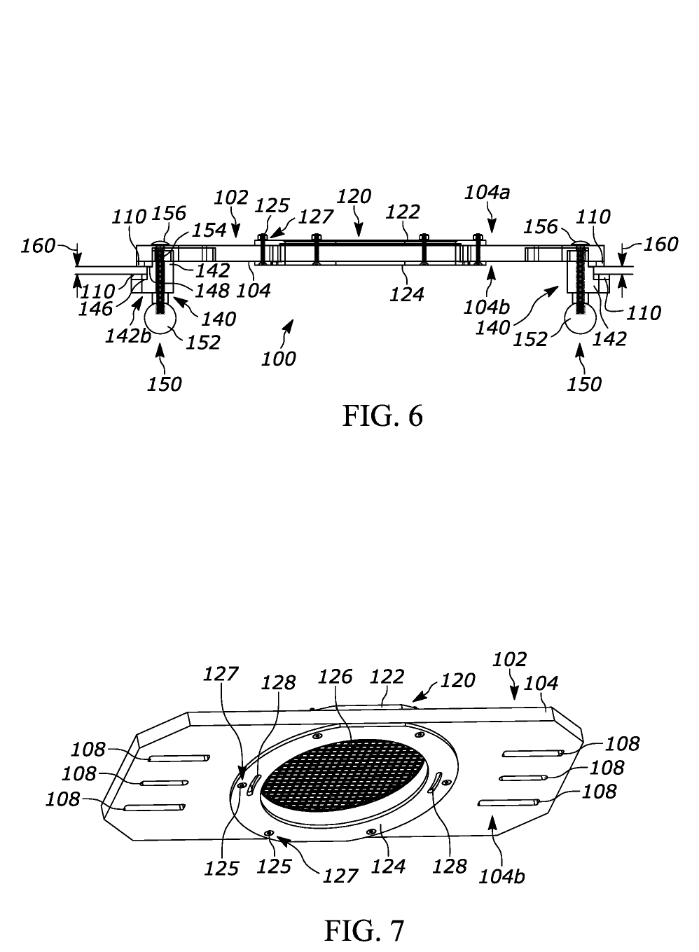

Once the supply hose 170 is coupled with the hose coupling bracket, preconditioned air may be provided to the aircraft by 16. In some arrangements, a portable air conditioning unit (not illustrated) may be provided on a cart or other wheeled device that is positionable near the aircraft 10. In other examples, preconditioned air may be provided via a fixed connection originating from the terminal gate at which the aircraft 10 is situated. Other examples are possible. In any of these approaches, preconditioned air may quickly lower the temperature of the aircraft bay 16 and any electrical components contained therein. Notably, and as illustrated in FIG. 3, because the body 104 of the base plate 102 does not occupy the entire area of the opening 106, relatively warmer air within the aircraft bay 16 may be exhausted from the aircraft bay 16 while preconditioned air is being fed into the aircraft bay due to a recirculation effect.

So arranged, the described systems may provide suitable cooling and/or ventilation to the aircraft bay to minimize and/or eliminate the occurrence of electronic overheat conditions on the aircraft while the aircraft is on the ground at boarding gates. Such a system may result in significant cost reductions, as flight delays and/or cancellations may be greatly reduced. The systems described herein may allow for quick and secure coupling to the aircraft, and do not require a user to closely monitor the device during use. Notably, the systems described herein may be used by airlines to cool the desired aircraft bay while on the ground with its engines being shut off due to the preconditioned air being sourced from either a mobile unit or the airport gate supply line.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein any reference to "one embodiment" or "an embodiment" means that a particular element, feature, structure, or characteristic described in connection with the embodiment is included in at least one embodiment. The appearances of the phrase "in one embodiment" in various places in the specification are not necessarily all referring to the same embodiment.

Some embodiments may be described using the expression "coupled" and "connected" along with their derivatives. For example, some embodiments may be described using the term "coupled" to indicate that two or more elements are in direct physical or electrical contact. The term "coupled," however, may also mean that two or more elements are not in direct contact with each other, but yet still co-operate or interact with each other. The embodiments are not limited in this context.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the "a" or "an" are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

What is claimed is:

1. A cooling system for cooling an aircraft bay, the cooling system comprising:
a base plate defining a body and including an opening formed thereon;
a hose coupling bracket operably coupled with the base plate and being positioned at or near the opening; and
at least one support arm movably coupled with the base plate;
wherein the body of the base plate and the at least one support arm define a gap to receive a portion of a fuselage of an aircraft therebetween.

2. The cooling system of claim 1, further comprising a supply hose, the supply hose adapted to couple with the hose coupling bracket to supply preconditioned air to the aircraft bay.

3. The cooling system of claim 1, further comprising a screen member positioned within an interior region of the hose coupling bracket.

4. The cooling system of claim 1, further comprising at least one gripping pad, the at least one gripping pad operably coupled with the base plate or the at least one support arm.

5. The cooling system of claim 1, further including a securing knob engageable to reduce a dimension of the gap, the securing knob including a gripping member and a rod member, wherein the base plate includes a slot adapted to receive a portion of the rod member.

6. The cooling system of claim 5, wherein the securing knob is rotatably coupled with a portion of the at least one support arm, wherein the securing knob and the at least one support arm cooperate to reduce a dimension of the gap formed between the body of the base plate and the at least one support arm.

7. The cooling system of claim 1, wherein the base plate further comprises at least one linear guide slot adapted to guide movement of the at least one support arm along a linear direction.

8. The cooling system of claim 7, further comprising a stop coupled with the base plate, the stop configured to limit movement of the at least one support arm.

9. The cooling system of claim 1, wherein the hose coupling bracket includes a rotational engagement mechanism.

10. A method of cooling an aircraft bay of an aircraft, the method comprising:
removing an access door to expose a fuselage opening formed in a fuselage of the aircraft;
providing a base plate defining a body and including an opening formed thereon and a hose coupling bracket operably coupled therewith and being positioned at or near the opening, the base plate having at least one support arm movably coupled therewith;
positioning the at least one support arm in a first, inward position with respect to the base plate;
inserting a portion of the body of the base plate in the fuselage opening such that the body abuts a portion of the fuselage;
positioning the at least one support arm in a second, outward position with respect to the base plate such that the fuselage is disposed within a gap between the body and the at least one support arm; and
coupling a supply hose with the hose coupling bracket.

11. The method of claim 10, further comprising the step of operably coupling at least one gripping pad with the base plate or the at least one support arm such that the at least one gripping pad contacts a portion of the fuselage.

12. The method of claim 10, further comprising the step of engaging a securing knob to reduce a dimension of the gap, the securing knob including a gripping member and a rod member, wherein the base plate includes a slot adapted to receive a portion of the rod member.

13. The method of claim 12, wherein the securing knob is rotatably coupled with a portion of the at least one support arm, wherein the securing knob and the at least one support arm cooperate to reduce a dimension of the gap formed between the body of the base plate and the at least one support arm.

14. The method of claim 10, further comprising the step of guiding movement of the at least one support arm along a linear direction the base plate via at least one linear guide slot.

15. The method of claim 14, further comprising the step of providing a stop formed on the base plate, the stop configured to limit movement of the at least one support arm.

16. The method of claim 10, further wherein the step of coupling the supply hose with the hose coupling bracket includes engaging a rotational engagement mechanism.
